(19) United States
(12) Patent Application Publication
(10) Pub. No.: US 2021/0383028 A1
(43) Pub. Date: Dec. 9, 2021

(54) ANTI-PEEP PATCH

(71) Applicant: DONGGUAN TEC-MOTION ELECTRO OPTICAL CO., LTD., Dongguan City (CN)

(72) Inventor: WENWEN SUN, Dongguan City (CN)

(21) Appl. No.: 17/024,719

(22) Filed: Sep. 18, 2020

(30) Foreign Application Priority Data
Jun. 3, 2020 (CN) 202020988667.8

(51) Int. Cl. G06F 21/84; G06F 1/16

(52) U.S. Cl. CPC G06F 21/84; G06F 1/1609

(57) ABSTRACT

An anti-peep patch includes a privacy protection film and a magnetic area. The privacy protection film (or privacy filter) stands for an anti-peep film for protecting a user's privacy, and the privacy protection film is provided for controlling a light exit at a predetermined angle to protect a message displayed on screen, so that a message or an image displayed on the screen can be seen from the front side, but cannot be seen clearly from the left and right sides, and the magnetic areas on both left and right sides of the privacy protection film magnetically attract an iPad or a mobile device, and the anti-peep patch can be attached onto or removed from the iPad or the mobile device instantly.

### CROSS-REFERENCE TO RELATED APPLICATIONS

This non-provisional application claims priority under 35 U.S.C. § 119(a) on Patent Application No(s). 202020988667.8 filed in China on 2020 Jun. 3, the entire contents of which are hereby incorporated by reference.

### FIELD OF THE INVENTION

The present invention relates to the technical field of anti-peep patches, and more particularly to an anti-peep patch that can be attached onto or removed from an iPad or a mobile device instantly.

### BACKGROUND OF THE INVENTION

In recent years, the technology of mobile communications advances rapidly, and mobile devices such as iPad have become an indispensable item of our daily life. Ordinary people when going out can operate the iPad or mobile device to surf the Internet, transfer money, watch videos, place orders, listen to music, perform bank transfers, read electronic books, check the maps, play games, or carry out leisure activities easily.

However, when a viewer uses the aforementioned display devices in a public place such as an office, a train, a mass rapid transit, an airplane, etc., a person nearby or walking around may peep out the viewer's screen curiously, even though the viewer does not want others to spy on the messages displayed on the screen, and thus it is relatively difficult to protect the viewer's security and privacy.

Furthermore, more and more financial companies are devoted to the development of mobile transaction, mobile bank, digital bank, electronic billing and related business, so that users can break through the limitations of time and place and obtain relevant information at any time. As a result, the issue of safety and security has become an important subject. Once a user enters an instruction or password in public to obtain relevant information of a financial service, the user's financial conditions are exposed to danger, since an interested party can know about the user's financial conditions by peeping into the special digital information.

### SUMMARY OF THE INVENTION

Therefore, it is a primary objective of the present invention to provide an anti-peep patch for users to prevent others from peeping while the user is viewing the screen.

Another objective of the present invention is to provide an anti-peep patch that can be attached onto or removed from an iPad or a mobile device instantly.

To achieve the aforementioned and other objectives, the present invention discloses an anti-peep patch comprising a privacy protection film and a magnetic area. The privacy protection film is provided for controlling a light exit at a predetermined angle to protect a message displayed on screen, so that the message or any other image displayed on the screen can be seen from the front side, but cannot be seen clearly from the left and right sides, and the magnetic areas on both left and right sides of the privacy protection film magnetically attract an iPad or a mobile device, so that the anti-peep patch can be attached onto or removed from the iPad or the mobile device instantly.

In addition, the present invention further discloses an anti-peep patch comprising a privacy protection film and at least one adhesive member installed on a side of a square frame of the privacy protection film, and the square frame of the privacy protection film is installed with an adhesive member to prevent the privacy protection film from producing a displacement with respect to the mobile device by an external force.

### BRIEF DESCRIPTION OF THE DRAWINGS

FIG. 1 is a perspective view of an anti-peep patch used in a mobile device in accordance with the present invention;

FIG. 2 is an exploded view of an anti-peep patch used in a mobile device in accordance with a first embodiment of the present invention;

FIG. 3 is an exploded view of the riverside side of an anti-peep patch in accordance with the first embodiment of the present invention;

FIG. 4 is a perspective view of an anti-peep patch used in a mobile device in accordance with the first embodiment of the present invention;

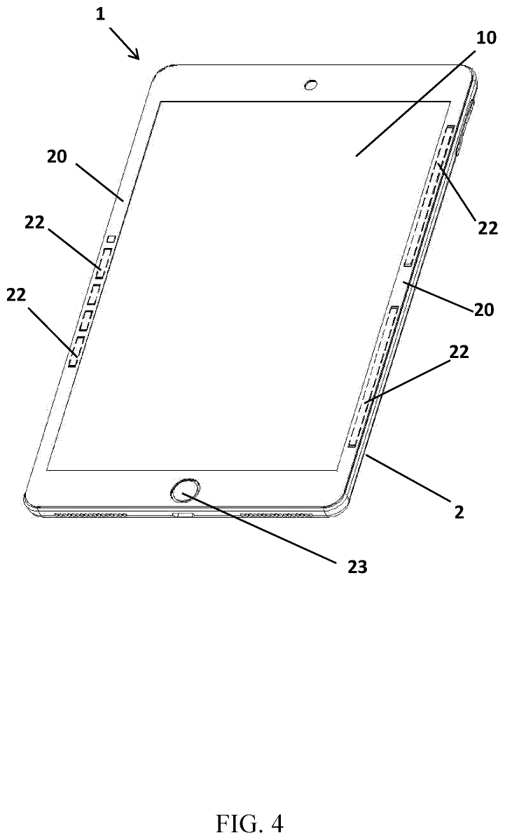

FIG. 5 is an exploded view of an anti-peep patch used in a mobile device in accordance with a second embodiment of the present invention;

FIG. 6 is an exploded view of the riverside side of an anti-peep patch in accordance with the second embodiment of the present invention;

FIG. 7 is a perspective view of an anti-peep patch used in a mobile device in accordance with the second embodiment of the present invention;

FIG. 8 is an exploded view of an anti-peep patch used in a tablet PC in accordance with a third embodiment of the present invention; and

FIG. 9 is a perspective view of an anti-peep patch used in a tablet PC in accordance with the third embodiment of the present invention.

### DESCRIPTION OF THE PREFERRED EMBODIMENTS

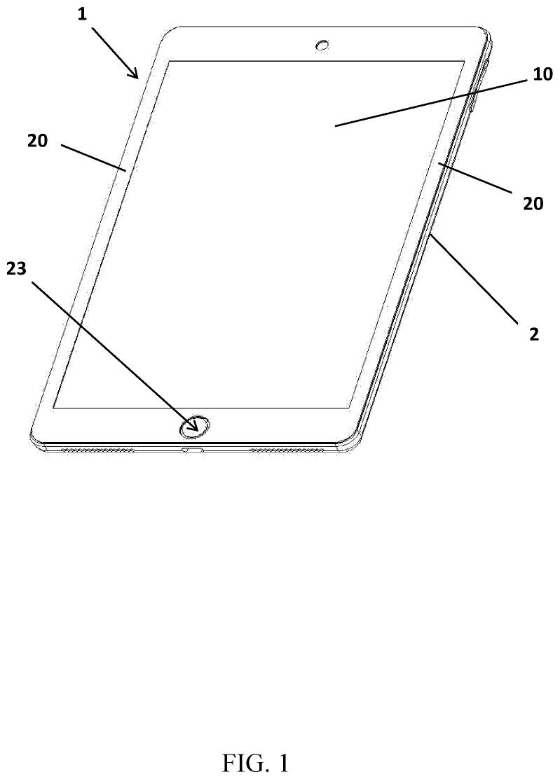

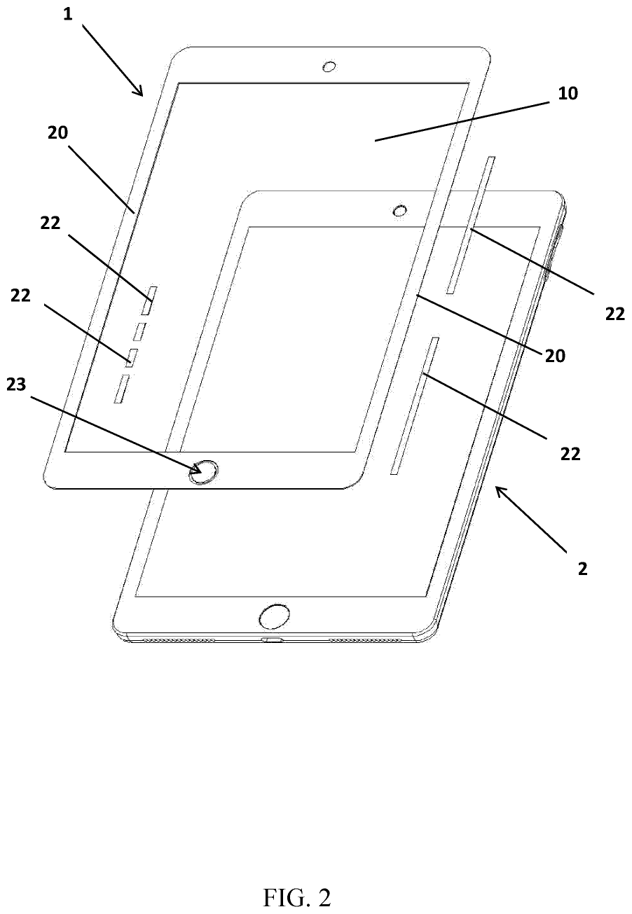

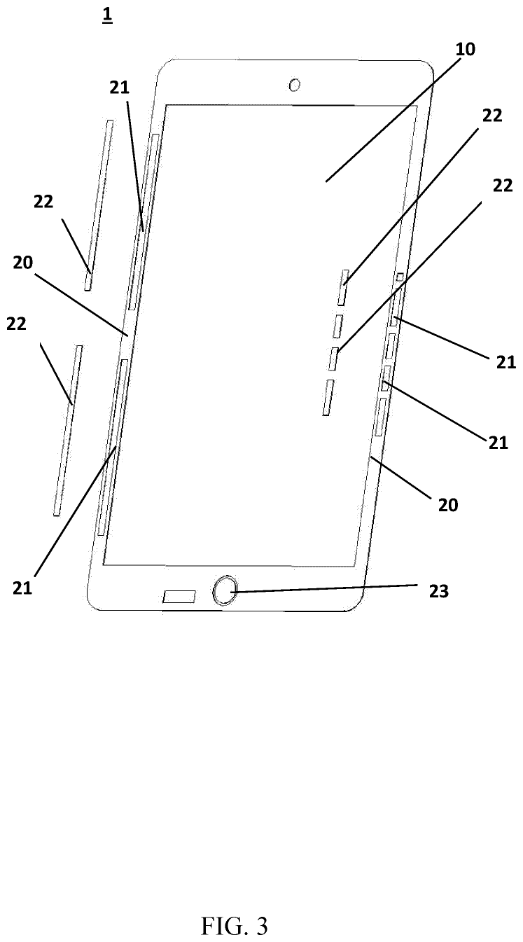

With reference to FIGS. 1 to 3 for a perspective view of an anti-peep patch 1 used in a mobile device 2 in accordance with the present invention, an exploded view of the anti-peep patch 1 used in the mobile device 2 and a perspective view of the reverse side of the anti-peep patch 1 used in the mobile device 2 in accordance with the first embodiment of the present invention respectively, the anti-peep patch 1 comprises a privacy protection film 10 and a magnetic area 20. The privacy protection film 10 (or privacy filter) is an anti-peep film that controls a light exit at a predetermined angle to protect a message displayed on a screen, so that the message displayed on the screen can be seen from the front of the screen but is difficult to be seen clearly from both left and right sides of the screen.

The privacy protection film 10 has a micro grating structure layer with a plurality of gratings arranged parallel to each other, so that the gratings can be formed by mixing and curing high polymer plastic materials and pigments, and the grating interval falls within a range of 0.01 mm-0.1 mm. Just like the principle of optics of a vertical blind, the privacy protection film 10 can narrow a viewable angle of 180 degrees of a planar display interface 180 to a viewable angle of 25, 30, or 45 degrees of both left and right triangles, etc., or limit the light of an image to a user's viewing angle. When the user's left and right triangular viewing angle with respect to the center exceeds 20˜45 degrees, the visibility is decreasing, the deviation of the viewing angle is increasing, and the brightness is dropping or even becoming totally dark in order to protect confidential image information and prevent others from peeping confidential information. Even when operating an IPad or a mobile device at work, office, school, café, or any other public place, the users no longer have to worry about their video messages and confidential information being spied by others.

In this embodiment, a square frame adjacent to the privacy protection film 10 and the privacy protection film 10 are made of non-homogeneous materials, and the square frame adjacent to the privacy protection film 10 may include other opaque polymer materials, and the anti-peep direction of the privacy protection film 10 can prevent peeping from both left and right viewing angles, or from up, down, left, and right panoramic view. The privacy protection film 10 has a thickness falling within a range of 1 mm˜0.1 mm. The privacy protection film 10 has a light transmittance falling within a range of 50%˜90%, so that the whole privacy protection film 10 is slightly greyish. Wherein, a finger touch area 23 is extended under the privacy protection film 10, and the finger touch area 23 can be a thin film, an opening, or a through hole and provided for turning open a screen or identifying a fingerprint, etc.

In an embodiment, the magnetic area 20 is disposed on both left and right sides of the privacy protection film 10, and the magnetic area 20 has a plurality of accommodating grooves 21 and a plurality of magnets 2. In some embodiments, the accommodating grooves 21 are formed by an etching process, but the present invention is not limited to such formation method only. The magnet 22 is formed by iron oxide, an iron alloy of the elements of aluminum (Al), nickel (Ni), and cobalt (Co), a rare earth magnet, a neodymium-iron-boron (NdFeB) magnet, and a samarium-cobalt (SmCo) magnet. The quantity and shape of the magnet 22 can be designed and adjusted freely according to actual needs by a person having ordinary skill in the art, so that there is no specific limitation on the quantity and shape of the magnet 22. The magnets 22 can be embedded into the accommodating grooves 21 respectively (by adhesion, hot-melt adhesion or ultrasonic adhesion, etc., so that the magnet 22 and the accommodating groove 21 can stick together to achieve the effect of fixing the magnet 22 into the accommodating groove 21), so as to form the magnetic area 20. Wherein, the magnetic area 20 can be a square frame corresponding to the square frame surrounding the iPad or the mobile device 2.

The magnetic areas 20 on both left and rights of the privacy protection film 10 are provided for magnetically attracting the square frame around the iPad or the mobile device 2, and the anti-peep patch 1 can be attached onto or removed from the iPad or the mobile device 2 instantly.

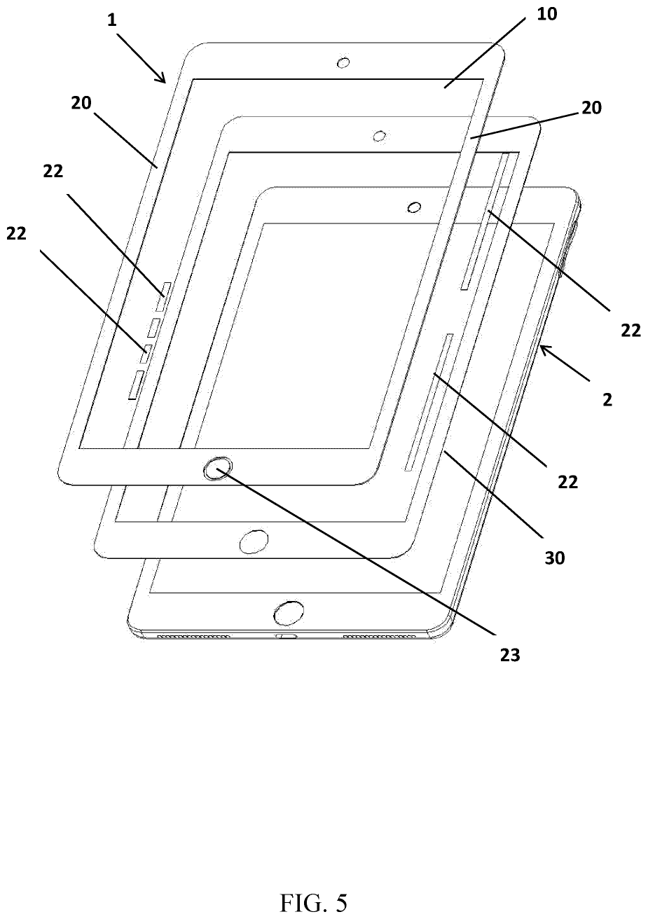

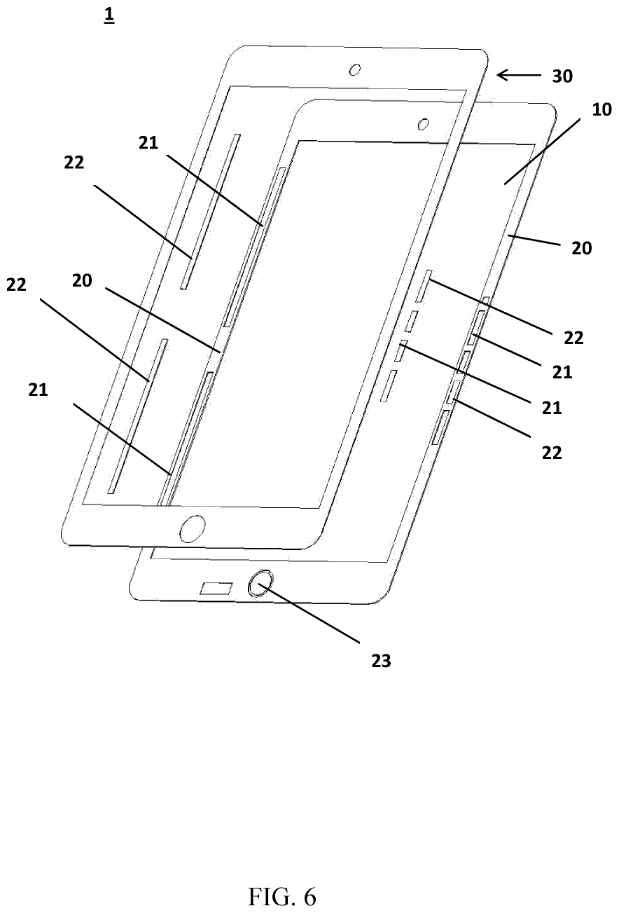

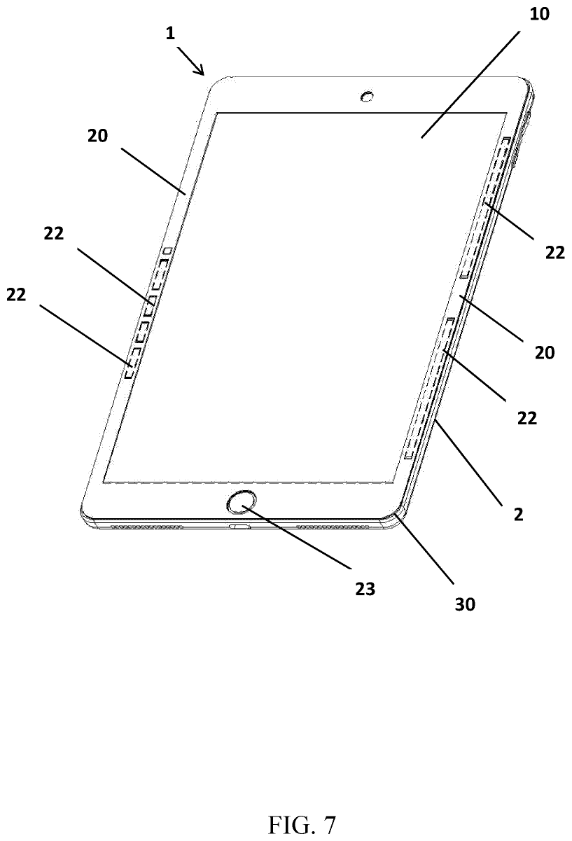

With reference to FIGS. 5 to 7 for an exploded view of an anti-peep patch used in a mobile device, an exploded view of a reverse side of the anti-peep patch used in the mobile device, and a perspective view of the anti-peep patch used in the mobile device in accordance with the second embodiment of the present invention respectively, this embodiment is substantially the same as the first embodiment, except that the anti-peep patch 1 of this embodiment further comprises a joint frame 30 which is not a necessary component, so that the first embodiment omits the joint frame 30, and the joint frame 30 of this embodiment can be a square frame. The square frame of the joint frame 30 is configured to be corresponsive to the square frame disposed around the magnetic area 20 of the privacy protection film 10 and the joint frame 30 is provided for engaging an opening of the accommodating groove 21 in the magnetic area 20 to block the magnet 22. The joint frame 30 is permanently adhered with the magnetic area 20 (by adhesion, hot melt adhesion, or ultrasonic adhesion, etc.), so that the joint frame 30 and the opening of the accommodating groove 21 stick together to achieve the effect of fixing the magnet 22 into the accommodating groove 21.

The magnetic areas 20 on the left and right sides of the privacy protection film 10 are provided for magnetically attract the square frame around the iPad or the mobile device 2 through the joint frame 30, and the anti-peep patch 1 can be attached onto or removed from the iPad or the mobile device 2 instantly.

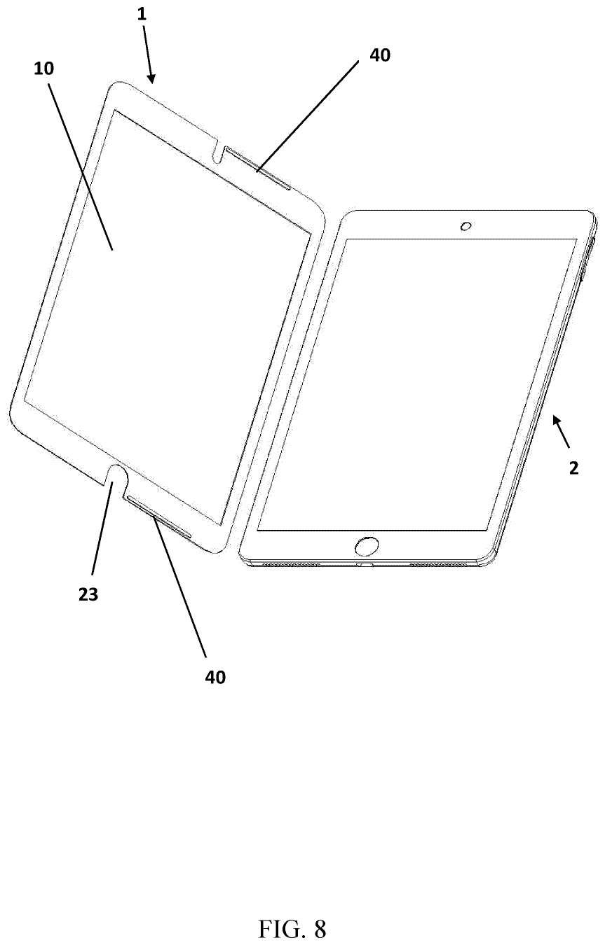

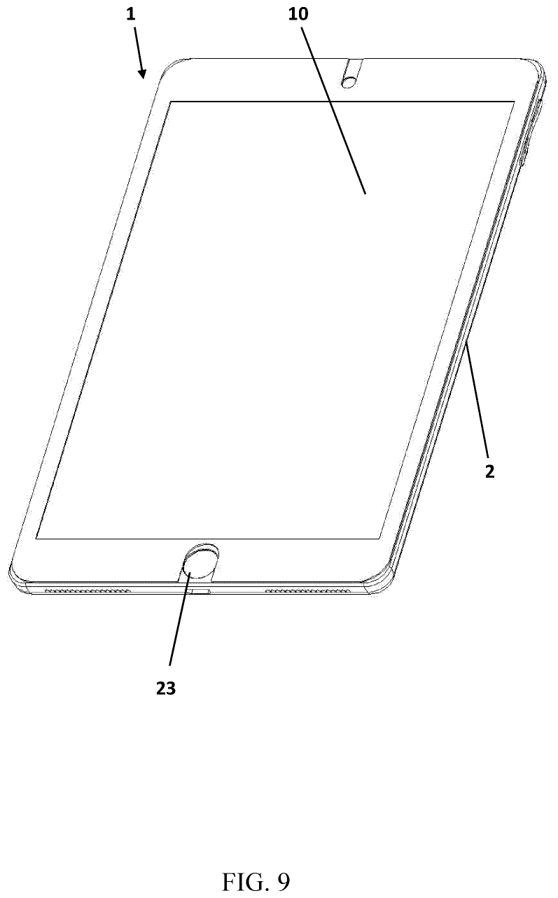

With reference to FIGS. 8 and 9 for the exploded view and a perspective view of an anti-peep patch used in a tablet PC in accordance with the third embodiment of the present invention respectively, the anti-peep patch 1 further comprises an adhesive member 40 disposed on a side of the privacy protection film 10, and a square frame adjacent to the privacy protection film 10 can be made of an opaque polymer material, and a side of the adhesive member 40 is sticky, so that the adhesive member can be adhered with a surface of the mobile device 2 to prevent the privacy protection film 10 from producing a replacement with respect to the mobile device 2 by an external force. In other embodiments, the adhesive member 40 has a certain thickness, so that a side of the adhesive member 40 abuts against a surface of the mobile device to prevent the privacy protection film 10 from producing a displacement with respect to the mobile device 2 due to friction.

While the invention has been described by means of specific embodiments, numerous modifications and variations could be made thereto by those skilled in the art without departing from the scope and spirit of the invention as set forth in the claims.

What is claimed is:

1. An anti-peep patch, comprising:
a privacy protection film; and
a magnetic area, disposed on at least one side of the privacy protection film, and comprising a plurality of accommodating grooves and a plurality of magnets embedded into the accommodating grooves respectively, and the accommodating grooves being formed by an etching process.

2. The anti-peep patch as claimed in claim 1, further comprising an adhesive member disposed on a side of the privacy protection film, and a side of the adhesive member being sticky, so that the adhesive member can be adhered with a surface of a mobile device to prevent the privacy protection film from producing a displacement with respect to the mobile device by an external force.

3. The anti-peep patch as claimed in claim 1, wherein the privacy protection film has a finger touch area extended from the bottom thereof.

4. The anti-peep patch as claimed in claim 1, wherein the privacy protection film is a grating structure.

5. The anti-peep patch as claimed in claim 1, further comprising a joint frame configured to be corresponsive to the magnetic area for engaging with an opening of the magnetic area to block the magnet.

6. The anti-peep patch as claimed in claim 5, wherein the magnetic area is a square frame, and the joint frame is a square frame.
